(19) United States
(12) Patent Application Publication
(10) Pub. No.: US 2014/0013210 A1
(43) Pub. Date: Jan. 9, 2014

(54) OPENING CUSTOM EXTENSIBLE MARKUP LANGUAGE DOCUMENTS IN A WORD PROCESSOR

(71) Applicant: Steffen Richard FREDERIKSEN, Skanderborg (DK)

(72) Inventor: Steffen Richard FREDERIKSEN, Skanderborg (DK)

(73) Assignee: DITA EXCHANGE, INC., Campbell, CA (US)

(21) Appl. No.: 13/543,035

(22) Filed: Jul. 6, 2012

(51) Int. Cl. G06F 17/21

(52) U.S. Cl. 715/235

(57) ABSTRACT

A method includes transforming a document that includes a custom extensible markup language (XML) element using a stylesheet. The method further includes removing the custom XML element from a first part of the document. The method further includes storing a text element that includes an attribute in place of the removed custom XML element within the first part of the document. The method further includes storing the custom XML element within a second part of the document. The method further includes adding the attribute to the second part of the document, where the attribute links the text element with the custom XML element. The method further includes opening the Open Office XML document within a word processor. The method further includes replacing the text element with the custom XML element within the word processor.

### BACKGROUND

1. Field

Certain embodiments of the invention relate generally to computer systems, and, more particularly, to computer systems that are configured to edit documents.

2. Description of the Related Art

Extensible markup language (XML) electronic documents (i.e., documents) generally include an XML tagging schema. For example, an XML document can include one or more elements, where each element can begin with a start-tag and end with an end-tag. Such tags can be highlighted within an XML editor, in order to provide visibility to the tagging schema, and to aid the user in identifying one or more pairs of tags.

If a user edits an XML document using current versions of Microsoft's word processor, Microsoft Word® (either Microsoft Word® 2007 or Microsoft Word® 2010), a user is generally not able to preserve tagging, such as custom XML tags, which can be present in an XML document. More specifically, if a user opens an XML document that includes tagging, using current versions of Microsoft Word®, the tagging is generally lost. Furthermore, if the user saves the XML document within Microsoft Word®, the XML document is saved as a text document without the tagging. Similarly, if a user opens an Open XML document that contains one or more custom XML tags, using current versions of Microsoft Word®, the one or more custom XML tags are generally stripped out of the Open XML document. Furthermore, saving the Open XML document within Microsoft Word® generally results in the Open XML document losing any trace of the original custom XML tags.

### SUMMARY

According to an embodiment of the invention, a method includes transforming a document that includes a custom XML element into an Open Office XML document that includes the custom XML element using an XSLT stylesheet. The method further includes removing the custom XML element from a document part of the Open Office XML document. The method further includes storing a text element that includes an attribute in place of the removed custom XML element within the document part of the Open Office XML document. The method further includes storing the custom XML element within a custom XML document part of the Open Office XML document. The method further includes adding the attribute to the custom XML document part of the Open Office XML document, where the attribute links the text element with the custom XML element. The method further includes opening the Open Office XML document within a Microsoft Office Word® word processor. The method further includes replacing the text element with the custom XML element within the Microsoft Office Word® word processor.

According to another embodiment, an apparatus includes a memory configured to store one or more modules. The apparatus further includes a processor configured to execute one or more modules stored within the memory. The apparatus further includes a transformation module configured to transform a document that includes a custom XML element into an Open Office XML document that includes the custom XML element using an XSLT stylesheet. The apparatus further includes a custom XML element removal module configured to remove the custom XML element from a document part of the Open Office XML document. The apparatus further includes a text element storage module configured to store a text element that includes an attribute in place of the removed custom XML element within the document part of the Open Office XML document. The apparatus further includes a custom XML element storage module configured to store the custom XML element within a custom XML document part of the Open Office XML document. The apparatus further includes an attribute module configured to add the attribute to the custom XML document part of the Open Office XML document, where the attribute links the text element with the custom XML element. The apparatus further includes a document opening module configured to open the Open Office XML document within a Microsoft Office Word® word processor. The apparatus further includes a replacement module configured to replace the text element with the custom XML element within the Microsoft Office Word® word processor.

According to another embodiment, a non-transitory computer-readable medium, including a computer program embodied therein, is configured to control a processor to implement a method. The method includes transforming a document that includes a custom XML element into an Open Office XML document that comprises the custom XML element using an XSLT stylesheet. The method further includes removing the custom XML element from a document part of the Open Office XML document. The method further includes storing a text element that includes an attribute in place of the removed custom XML element within the document part of the Open Office XML document. The method further includes storing the custom XML element within a custom XML document part of the Open Office XML document. The method further includes adding the attribute to the custom XML document part of the Open Office XML document, where the attribute links the text element with the custom XML element. The method further includes opening the Open Office XML document within a Microsoft Office Word® word processor. The method further includes replacing the text element with the custom XML element within the Microsoft Office Word® word processor.

### BRIEF DESCRIPTION OF THE DRAWINGS

Further embodiments, details, advantages, and modifications of the present invention will become apparent from the following detailed description of the preferred embodiments, which is to be taken in conjunction with the accompanying drawings, wherein:

FIG. 1 illustrates a block diagram of an apparatus, according to an embodiment of the invention.

FIG. 2 illustrates a block diagram of a process for opening a document that comprises one or more custom XML elements within a word processor, according to an embodiment of the invention.

FIG. 3 illustrates a block diagram of a process for opening a document that comprises one or more custom XML elements within a word processor, according to another embodiment of the invention.

FIG. 4 illustrates a document where a custom XML element has been replaced with a text element, according to an embodiment of the invention.

FIG. 5 illustrates a method, according to an embodiment of the invention.

### DETAILED DESCRIPTION

It will be readily understood that the components of the present invention, as generally described and illustrated in the figures herein, may be arranged and designed in a wide variety of different configurations. Thus, the following detailed description of the embodiments of a method, apparatus, system, and computer-readable medium, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, the usage of the phrases “an embodiment,” “one embodiment,” “another embodiment,” “an alternative embodiment,” “an alternate embodiment,” “certain embodiments,” “some embodiments,” “different embodiments” or other similar language, throughout this specification refers to the fact that a particular feature, structure, or characteristic described in connection with the embodiment may be included in at least one embodiment of the present invention. Thus, appearances of the phrases “an embodiment,” “one embodiment,” “another embodiment,” “an alternative embodiment,” “an alternate embodiment,” “in certain embodiments,” “in some embodiments,” “in other embodiments,” “in different embodiments,” or other similar language, throughout this specification do not necessarily all refer to the same group of embodiments, and the described features, structures, or characteristics may be combined in any suitable manner in one or more embodiments.

According to one embodiment, a user can open any custom XML document, described by an XML schema, in any word processor, such as any current version of Microsoft's word processor, Microsoft Word® (e.g., Microsoft Word® 2007 or Microsoft Word® 2010), and any future version of Microsoft Word® that is compliant with International Organization for Standardization (ISO)/International Electrotechnical Commission (IEC) standard 29500, which is a standard for word-processing documents, presentations, and spreadsheets. The user can edit the custom XML document and save the custom XML document within the word processor, such as Microsoft Word®, and retain all custom XML tagging within the document.

In the following description, the following terms are used as synonyms: Office Open XML document, Open XML document, and/or Microsoft Word® document. All refer to the Microsoft Word® 2007/2010 default document format (*.docx), as further described and defined by the Office Open XML specification standardized by Ecma (i.e., ECMA-376), and subsequently described and defined by ISO and IEC (i.e., ISO/IEC standard 29500).

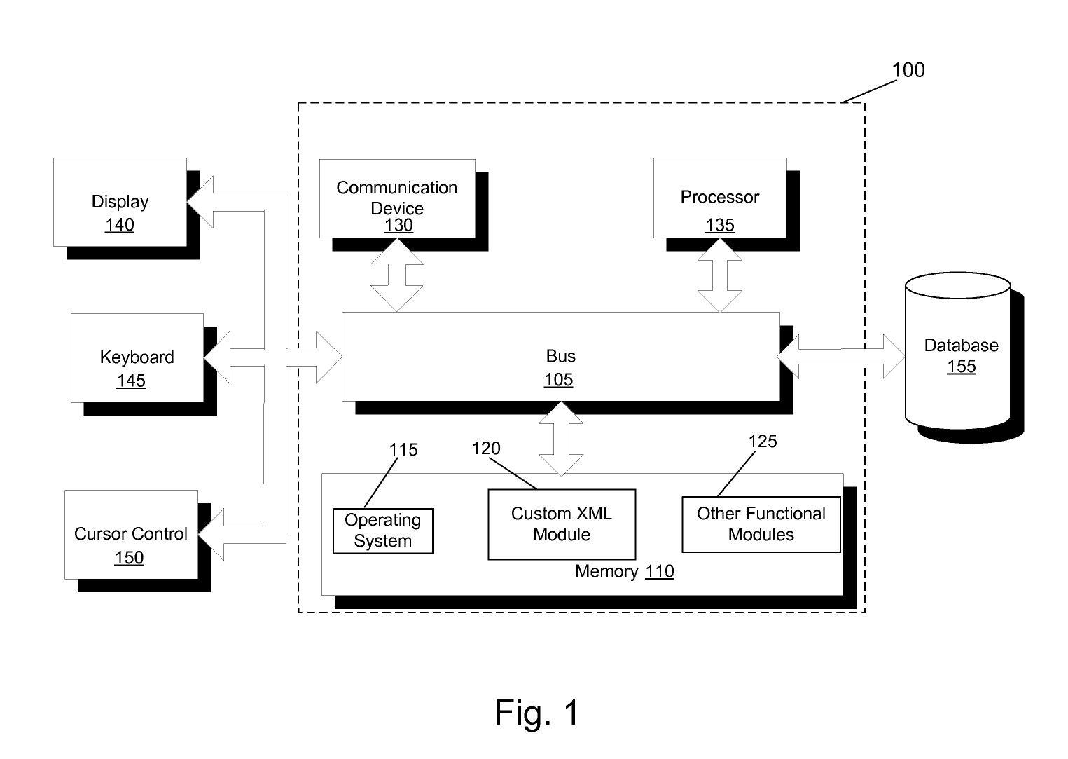

FIG. 1 illustrates a block diagram of an apparatus 100, according to an embodiment of the invention. Apparatus 100 includes a bus 105 or other communications mechanism for communicating information between components of apparatus 100. Apparatus 100 also includes a processor 135, operatively coupled to bus 105, for processing information and executing instructions or operations. Processor 135 may be any type of general or specific purpose processor. Apparatus 100 further includes a memory 110 for storing information and instructions to be executed by processor 135. Memory 110 can be comprised of any combination of random access memory (RAM), read only memory (ROM), static storage such as a magnetic or optical disk, or any other type of machine or computer-readable medium. Apparatus 100 further includes a communication device 130, such as a network interface card or other communications interface, to provide access to a network. As a result, a user may interface with apparatus 100 directly, or remotely through a network or any other method. In addition, apparatus 100 may interface with any resources through a network using communication device 130.

A computer-readable medium may be any available medium that can be accessed by processor 135. A computer-readable medium may include both a volatile and nonvolatile medium, a removable and non-removable medium, and a storage medium. A storage medium may include RAM, flash memory, ROM, erasable programmable read-only memory (EPROM), electrically erasable programmable read-only memory (EEPROM), registers, hard disk, a removable disk, a compact disc read-only memory (CD-ROM), or any other form of storage medium known in the art.

Processor 135 can also be operatively coupled via bus 105 to a display 140, such as a Liquid Crystal Display (LCD). Display 140 can display information to the user. A keyboard 145 and a cursor control device 150, such as a computer mouse, can also be operatively coupled to bus 105 to enable the user to interface with apparatus 100.

According to one embodiment, memory 110 can store software modules (i.e., modules) that may provide functionality when executed by processor 135. The modules can include an operating system 115, a custom XML module 120, as well as other functional modules 125. Operating system 115 can provide an operating system functionality for apparatus 100. Custom XML module 120 can provide functionality for opening a document that comprises one or more custom XML elements within a word processor, such as Microsoft Word®, as is described in more detail below. In certain embodiments, custom XML module 120 can comprise a plurality of modules that each provide specific individual functionality for opening a document that comprises one or more custom XML elements within a word processor, such as Microsoft Word®. Apparatus 100 can also be part of a larger system. Thus, apparatus 100 can include one or more additional functional modules 125 to include the additional functionality. In certain embodiments, additional functional modules 125 can include a word processor module that can provide functionality for word processing, such as opening, editing, and saving one or more documents. In some of these embodiments, the word processor module can be a Microsoft Word® module.

Processor 135 can also be operatively coupled via bus 105 to a database 155. Database 155 can store data in an integrated collection of logically-related records or files. Database 155 can be an operational database, an analytical database, a data warehouse, a distributed database, an end-user database, an external database, a navigational database, an in-memory database, a document-oriented database, a real-time database, a relational database, an object-oriented database, or any other database known in the art.

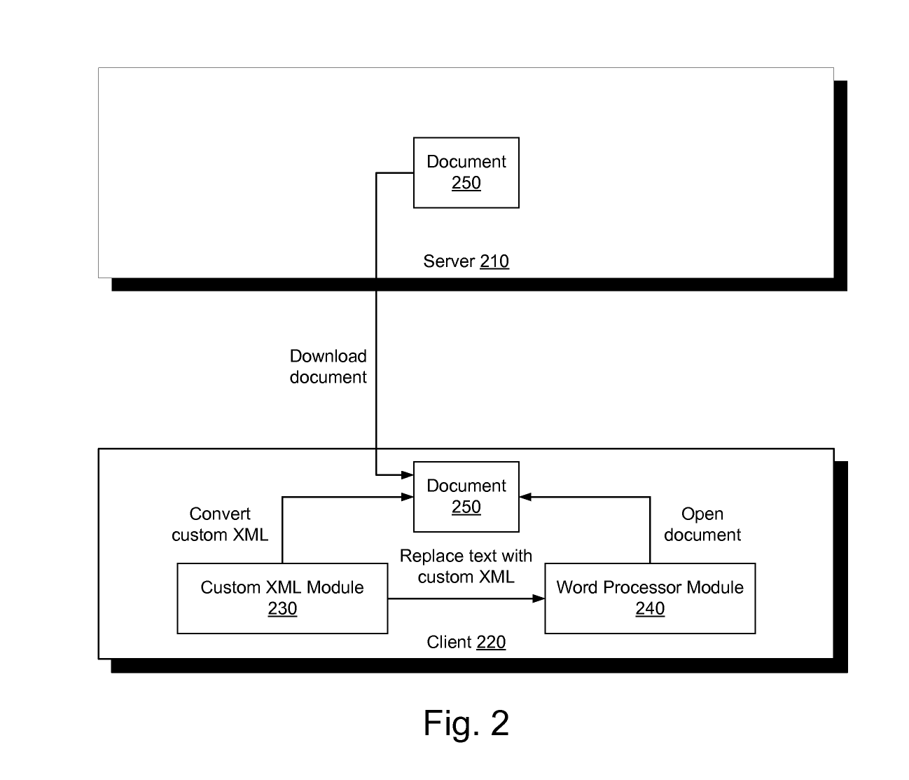

FIG. 2 illustrates a block diagram of a process for opening a document that comprises one or more custom XML elements within a word processor, according to an embodiment of the invention. According to the embodiment, the process involves a server 210 and a client 220. Server 210 can be any type of server that is known to one of ordinary skill in the relevant art, such as an application server, or a web server. In certain embodiments, server 210 is a content management server. A content management server is a server that provides functionality for publishing, editing, and modifying content, such as one or more documents. Such functionality can include: allowing multiple users to share and contribute to stored content; controlling access to content based on a role associated with a user; facilitating storage and retrieval of content; controlling content validity and compliance; reducing duplicate inputs of content; defining what type of content can be stored within the content management server (e.g., what type of documents can be stored), and producing one or more reports based on content stored. In certain embodiments, server 210 is a Microsoft SharePoint® server. Further, client 220 can be any computer system or software application that can access content stored on server 210, such as a personal computer, a laptop computer, a tablet computer, a personal digital assistant (PDA), or a mobile device.

According to the embodiment, client 220 includes custom XML module 230 and word processor module 240. Custom XML module 230 can provide functionality for opening a document that comprises one or more custom XML elements within a word processor, such as Microsoft Word®, as is described in more detail below. In certain embodiments, custom XML module 230 is identical to custom XML module 120 of FIG. 1. Word processor module 240 can provide functionality for word processing, such as opening, editing, and saving one or more documents. In some embodiments, word processor module 240 can be a Microsoft Word® module.

In certain embodiments, document 250 is stored within server 210. Document 250 is a document that includes one or more custom XML elements. In certain embodiments, document 250 is an XML document. In embodiments where document 250 is stored within server 210, document 250 can be downloaded onto client 220 as part of the process for opening document 250. The download of document 250 can be initiated by either server 210 or client 220. In alternate embodiments, document 250 is already stored within client 220. In these embodiments, the download of document 250 onto client 220 can be omitted from the process for opening document 250. In alternate embodiments, additional documents (not shown in FIG. 2) can be stored either within server 210 or client 220.

According to the embodiment, word processor module 240 can open document 250. In certain embodiments, where word processor module 240 is a Microsoft Word® module, word processor module 240 can display a list of commands to a user within a graphical user interface. A user can then select an open command, and word processor module 240 can display a list of documents, where the list of documents include document 250. In certain embodiments, document 250 can have a specific file extension (such as .DITA), and word processor module 240 can display a filtered list of documents, where only documents that have the specific file extension are displayed. A user can then select document 250 from the list of documents, and word processor module 240 can open document 250.

In the embodiment, as part of opening document 250, custom XML module 230 can be initiated as an “add-in” process. Custom XML module 230 can open document 250 and convert the one or more custom XML elements contained within document 250 to one or more text elements, where each text element serves as a placeholder for the corresponding custom XML element. The one or more text elements are stored within a document part of document 250, and the one or more custom XML elements are stored within a custom XML part of document 250. The conversion of the one or more custom XML elements to one or more text elements is described below in greater detail.

Furthermore, in the embodiment, as part of opening document 250, custom XML module 230 can cause word processor module 240 to open the document part of document 250 that contains the one or more text elements, and replace each text element with the corresponding custom XML element stored in the custom XML part of document 250. The replacing of the one or more text elements with one or more corresponding custom XML elements is also described below in greater detail. Thus, according to the embodiment, document 250, including its one or more custom XML elements, is opened by word processor module 240 as a word processor document. In the embodiments where word processor module 240 is a Microsoft Word® module, document 250 can be opened as a Microsoft Word® document.

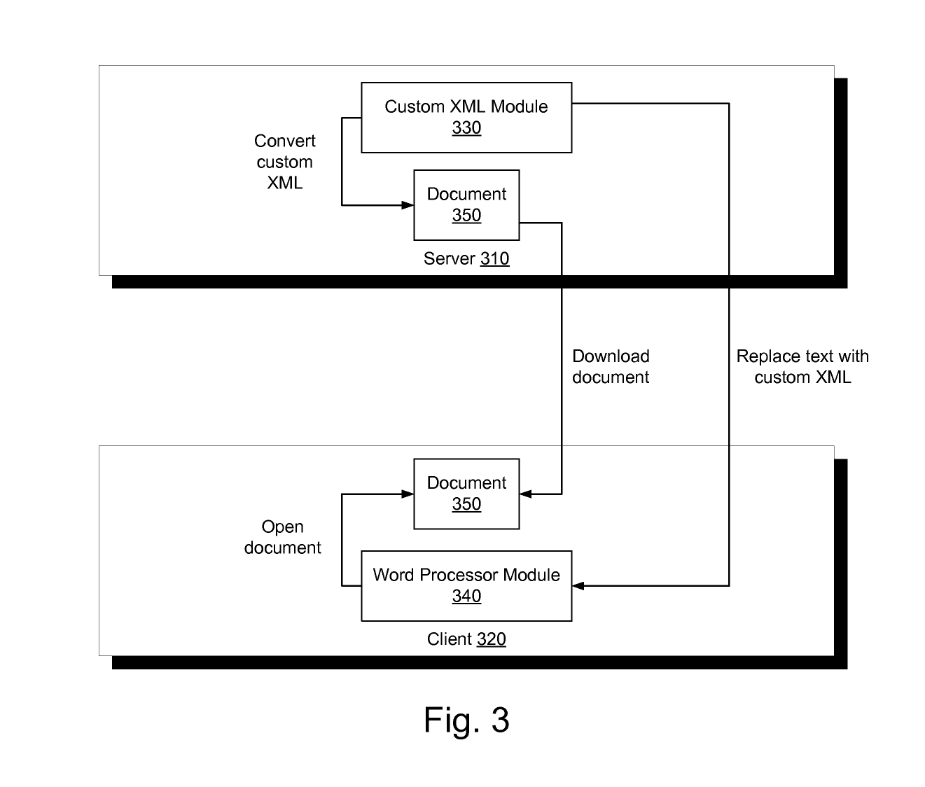

FIG. 3 illustrates a block diagram of a process for opening a document that comprises one or more custom XML elements within a word processor, according to another embodiment of the invention. According to the embodiment, the process involves a server 310 and a client 320. Similar to server 210 of FIG. 2, server 310 can be any type of server that is known to one of ordinary skill in the relevant art, such as an application server, or a web server. In certain embodiments, server 310 is a content management server. In some of those embodiments, server 310 is a Microsoft SharePoint® server. Further, client 320, similar to client 220 of FIG. 2, can be any computer system or software application that can access content stored on server 310, such as a personal computer, a laptop computer, a tablet computer, a PDA, or a mobile device.

According to the embodiment, server 310 includes custom XML module 330, and client 320 includes word processor module 340. Custom XML module 330, similar to custom XML module 230 of FIG. 2, can provide functionality for opening a document that comprises one or more custom XML elements within a word processor, such as Microsoft Word®, as is described in more detail below. In certain embodiments, custom XML module 330 is identical to custom XML module 120 of FIG. 1. Word processor module 340, similar to word processor module 240 of FIG. 2, can provide functionality for word processing, such as opening, editing, and saving one or more documents. In some embodiments, word processor module 340 can be a Microsoft Word® module. A significant distinction between the illustrated embodiment of FIG. 2 and the illustrated embodiment of FIG. 3 is that, in the illustrated embodiment of FIG. 3, custom XML module 330 is implemented at server 310 rather than client 320.

In certain embodiments, document 350 is stored within server 310. Document 350, similar to document 250 of FIG. 2, is a document that includes one or more custom XML elements. In certain embodiments, document 350 is an XML document. In embodiments where document 350 is stored within server 310, document 350 can be downloaded onto client 320 as part of the process for opening document 350. The download of document 350 can be initiated by either server 310 or client 320. In alternate embodiments, document 350 is already stored within client 320. In these embodiments, the download of document 350 onto client 320 can be omitted from the process for opening document 350. In alternate embodiments, additional documents (not shown in FIG. 3) can be stored either within server 310 or client 320.

According to the embodiment, custom XML module 330 can open document 350 and convert the one or more custom XML elements contained within document 350 to one or more text elements, where each text element serves as a placeholder for the corresponding custom XML element. The one or more text elements are stored within a document part of document 350, and the one or more custom XML elements are stored within a custom XML part of document 350. The conversion of the one or more custom XML elements to one or more text elements is described below in greater detail.

Furthermore, according to the embodiment, custom XML module 330 can cause word processor module 340 to open document 350. As part of opening document 350, custom XML module 330 can cause word processor module 340 to open the document part of document 350 that contains the one or more text elements, and replace each text element with the corresponding custom XML element stored in the custom XML part of document 350. The replacing of the one or more text elements with one or more corresponding custom XML elements is also described below in greater detail. Thus, according to the embodiment, document 350, including its one or more custom XML elements, is opened by word processor module 340 as a word processor document. In the embodiments where word processor module 340 is a Microsoft Word® module, document 350 can be opened as a Microsoft Word® document.

As previously described, an XML document can be opened within a word processor, such as Microsoft Word®, according to embodiments of the invention. According to certain embodiments, the XML document is first transformed using a specially constructed extensible stylesheet language transformation (XSLT) stylesheet. The stylesheet can, if desired, add specific Microsoft Word® styling to the one or more custom XML elements contained within the XML document, and the transformation output (i.e., the document part of an Open XML package) can comprise valid Office Open XML, where the one or more custom XML elements can be transformed into equivalent Office Open XML elements. The transformation output can then be inserted into an Office Open XML Word package. The Office Open XML Word package can be constructed using a special Microsoft Word® template file in certain embodiments. In certain embodiments, one or more links, lists, and other components that are not part of the document part of the Open XML package can be resolved. The original XML document can then be inserted into a custom XML document part of the Office Open XML Word package.

According to certain embodiments, the one or more custom XML elements in the document part of the Office Open XML Word package can be removed and replaced with one or more sequentially-numbered text elements. The one or more custom XML elements of the original XML document that are contained inside the custom XML document part of the Office Open XML Word package can further be edited to include a sequential number attribute, so that the sequentially-numbered text elements each reference to a sequential number attribute added to the one or more custom XML elements. As a result, the document part of the Office Open XML Word package includes one or more sequentially-numbered text elements, where each sequentially-numbered text element refers to a corresponding custom XML element included within the custom XML part of the Office Open XML Word package.

The resulting Open XML Word package is subsequently opened using processing of the word processor, such as Microsoft Word®. At this stage, the opened word processor document (e.g., Microsoft Word® document) does not contain any custom XML elements within the document part of the Open XML Word package. An add-in subsequently processes, using an application programming interface (API) of the word processor, the Open XML Word package by removing each of the one or more sequentially-numbered text elements, and replacing them with the corresponding one or more custom XML elements contained in the custom XML part of the Open XML Word package.

According to embodiments of the invention, this process effectively opens an XML document within a word processor, such as Microsoft Word®, preserving the one or more custom XML elements contained within the XML document. In certain embodiments, the document can be saved with all of the one or more custom XML elements intact. Alternatively, in certain embodiments, the document can be edited within the word processor, and the one or more custom XML elements can be preserved.

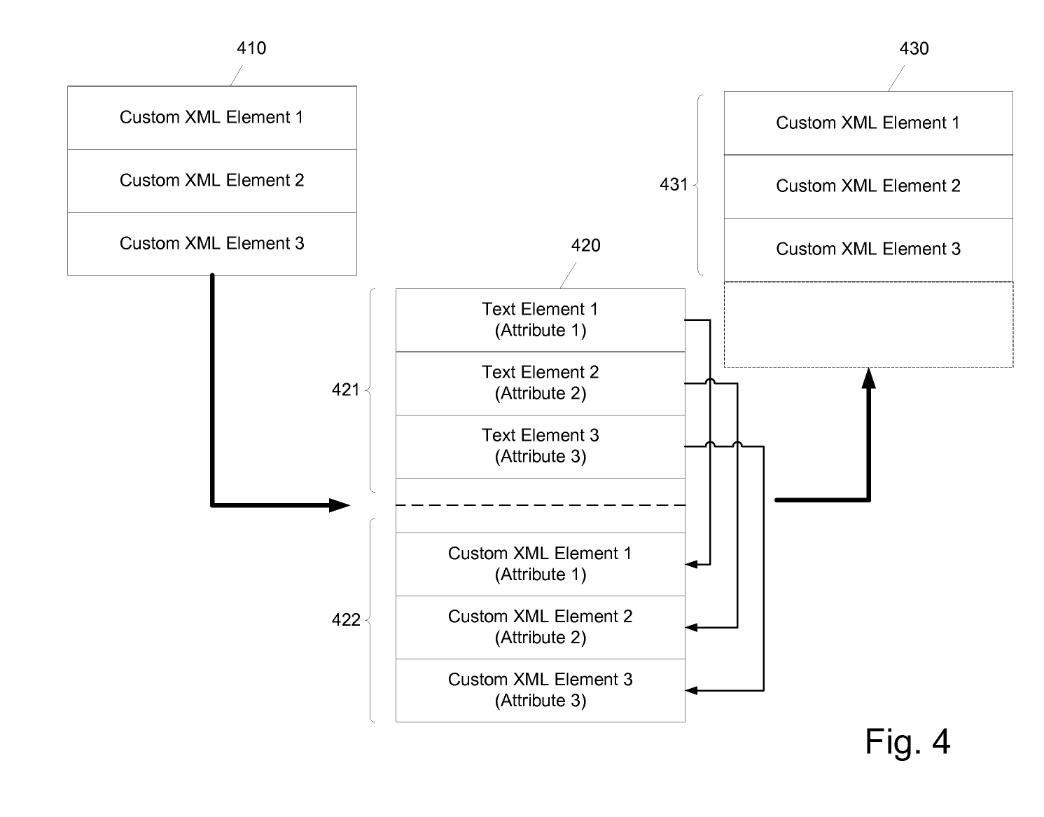

FIG. 4 illustrates a document where a custom XML element has been replaced with a text element, according to an embodiment of the invention. More specifically, FIG. 4 illustrates a document 410 that includes three custom XML elements, custom XML element 1, custom XML element 2, and custom XML element 3. One of ordinary skill in the art would readily appreciate that the number of custom XML elements included within document 410 is merely an example, and that, in alternate embodiments, document 410 can include any number of custom XML elements. In certain embodiments, document 410 is an XML document.

According to the illustrated embodiment, document 410 is transformed using an XSLT stylesheet, where the custom XML elements (i.e., custom XML elements 1, 2, and 3) are transformed into Office Open XML elements, and the transformation output is inserted into an Office Open XML Word package 420. According to the embodiment, Office Open XML Word package 420 includes document part 421 and custom XML part 422. Also according to the embodiment, the transformation output is inserted into document part 421 of Office Open XML Word package 420 (not shown in FIG. 4).

According to the embodiment, as illustrated in FIG. 4, within document part 421 of Open XML Word package 420, custom XML element 1 is replaced with text element 1, custom XML element 2 is replaced with text element 2, and custom XML element 3 is replaced with text element 3. Furthermore, as also illustrated in FIG. 4, custom XML elements 1, 2, and 3 are stored within custom XML part of Open XML Word package 420. As also illustrated in FIG. 4, custom XML element 1 is edited to include attribute 1, custom XML element 2 is edited to include attribute 2, and custom XML element 3 is edited include attribute 3. Attributes 1, 2, and 3 are examples of attributes that can be added to a custom XML element to identify the custom XML element. As also illustrated in FIG. 4, text element 1 can include attribute 1, and thus, reference custom XML element 1. Likewise, text element 2 can include attribute 2, and thus, reference custom XML element 2, and text element 3 can include attribute 3, and thus, reference custom XML element 3. Thus, text elements 1, 2, and 3 can act as reference links to custom XML elements 1, 2, and 3, respectively. In certain embodiments, attributes 1, 2, and 3, are sequential numbers.

Furthermore, according to the embodiment, when Open XML Word package 420 is opened within a word processor, such as Microsoft Word®, Open XML Word package 420 is transformed into Open XML Word package 430 that includes a document part 431 and a custom XML part (not shown in FIG. 4), where, within document part 431, text element 1 is replaced with custom XML element 1 from the custom XML part, text element 2 is replaced with custom XML element 2 from the custom XML part, and text element 3 is replaced with custom XML element 3 from the custom XML part. Thus, Open XML Word package 430 can be opened within the word processor, where document part 431 includes custom XML elements 1, 2, and 3. According to the embodiment, attributes 1, 2, and 3, are removed from custom XML elements 1, 2, and 3 before custom XML elements 1, 2, and 3 are inserted into document part 431.

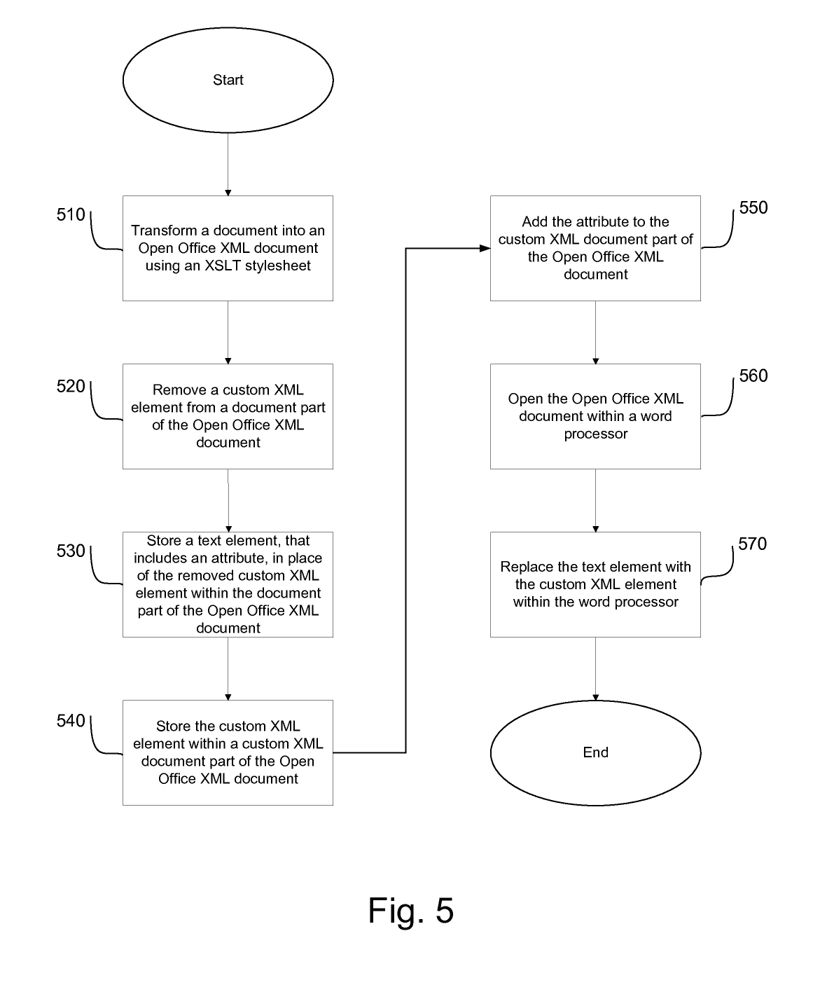

FIG. 5 illustrates a method according to an embodiment of the invention. The steps of a method or algorithm described in connection with the embodiments disclosed herein may be embodied directly in hardware, in a computer program executed by a processor, or in a combination of the two. A computer program may be embodied on a computer-readable medium, such as a storage medium. For example, a computer program may reside in RAM, flash memory, ROM, EPROM, EEPROM, registers, hard disk, a removable disk, a CD-ROM, or any other form of storage medium known in the art. An exemplary storage medium may be coupled to the processor such that the processor can read information from, and write information to, the storage medium. In the alternative, the storage medium may be integral to the processor. The processor and the storage medium may reside in an application specific integrated circuit (ASIC). In the alternative, the processor and the storage medium may reside as discrete components. Furthermore, a computer-readable medium may be any type of tangible medium.

The flow begins and proceeds to step 510. At step 510, a document that includes a custom XML element is transformed into an Open Office XML document that comprises the custom XML element using an XSLT stylesheet. The document can be an XML document. The custom XML element can be a custom Office Open XML element. The flow then proceeds to step 520.

At step 520, the custom XML element is removed from a document part of the Open Office XML document. The flow then proceeds to step 530.

At step 530, a text element that includes an attribute is stored in place of the removed custom XML element within the document part of the Open Office XML document. The attribute can be a sequential number. In certain embodiments, the storing of the text element can be performed at a content management server. In some of these embodiments, the content management server is a Microsoft Sharepoint® server. The flow then proceeds to step 540.

At step 540, the custom XML element is stored within a custom XML document part of the Open Office XML document. In certain embodiments, the storing of the custom XML element can be performed at a content management server. In some of these embodiments, the content management server is a Microsoft Sharepoint® server. The flow then proceeds to step 550.

At step 550, the attribute is added to the custom XML document part of the Open Office XML document, where the attribute links the text element with the custom XML element. The flow then proceeds to step 560.

At step 560, the Open Office XML document is opened within a word processor. The word processor can be a Microsoft Office Word® word processor. The flow then proceeds to step 570.

At step 570, the text element is replaced with the custom XML element within the Microsoft Office Word® word processor. In certain embodiments, the Open Office XML document can be subsequently saved as an XML document. In other embodiments, the Open Office XML document can be edited. The flow then ends.

Thus, according to certain embodiments, a document comprising one or more custom XML elements can be opened within a word processor, such as Microsoft Word®. As a result of the process previously described, an editable document containing the one or more custom XML elements can be opened within the word processor, where the opened document is available for editing and all other word processing functionality. If no editing is performed, the document can be saved as an XML document, effectively recreating the original custom XML document, and thus, provide true round-trip capabilities (i.e., XML document to word processor document to XML document) with no loss of information. In certain embodiments, the process can be very fast, where the process can be completed in less than one second using a standard Microsoft Windows® personal computer. Furthermore, the process can be customized, and can be utilized with any custom XML format that is guided by an XML schema.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

We claim:

1. A method, comprising:
transforming a document that comprises a custom extensible markup language (XML) element into an Open Office XML document that comprises the custom XML element using an extensible stylesheet language transformation (XSLT) stylesheet;
removing the custom XML element from a document part of the Open Office XML document;
storing a text element that comprises an attribute in place of the removed custom XML element within the document part of the Open Office XML document;
storing the custom XML element within a custom XML document part of the Open Office XML document;
adding the attribute to the custom XML document part of the Open Office XML document, wherein the attribute links the text element with the custom XML element;
opening the Open Office XML document within a Microsoft Office Word® word processor; and
replacing the text element with the custom XML element within the Microsoft Office Word® word processor.

2. The method of claim 1, wherein the document comprises an XML document.

3. The method of claim 1, wherein the attribute comprises a sequential number.

4. The method of claim 1, wherein the custom XML element comprises a custom Office Open XML element.

5. The method of claim 1, further comprising saving the Open Office XML document as a XML document.

6. The method of claim 1, further comprising editing the Open Office XML document.

7. The method of claim 1, wherein the storing the text element and the custom XML element is performed at a content management server.

8. The method of claim 7, wherein the content manager server comprises a Microsoft Sharepoint® server.

9. An apparatus, comprising:
a memory configured to store one or more modules;
a processor configured to execute one or more modules stored within the memory;
a transformation module configured to transform a document that comprises a custom extensible markup language (XML) element into an Open Office XML document that comprises the custom XML element using an extensible stylesheet language transformation (XSLT) stylesheet;
a custom XML element removal module configured to remove the custom XML element from a document part of the Open Office XML document;
a text element storage module configured to store a text element that comprises an attribute in place of the removed custom XML element within the document part of the Open Office XML document;
a custom XML element storage module configured to store the custom XML element within a custom XML document part of the Open Office XML document;
an attribute module configured to add the attribute to the custom XML document part of the Open Office XML document, wherein the attribute links the text element with the custom XML element;
a document opening module configured to open the Open Office XML document within a Microsoft Office Word® word processor; and
a replacement module configured to replace the text element with the custom XML element within the Microsoft Office Word® word processor.

10. The apparatus of claim 9, wherein the document comprises an XML document.

11. The apparatus of claim 9, wherein the attribute comprises a sequential number.

12. The apparatus of claim 9, wherein the custom XML element comprises a custom Office Open XML element.

13. The apparatus of claim 9, further comprising a saving module configured to save the Open Office XML document as a XML document.

14. The apparatus of claim 9, further comprising an editing module configured to edit the Open Office XML document.

15. The apparatus of claim 9, wherein the apparatus comprises a content management server.

16. The apparatus of claim 15, wherein the content manager server comprises a Microsoft Sharepoint® server.

17. A non-transitory computer-readable medium, comprising a computer program embodied therein, configured to control a processor to implement a method, the method comprising:
transforming a document that comprises a custom extensible markup language (XML) element into an Open Office XML document that comprises the custom XML element using an extensible stylesheet language transformation (XSLT) stylesheet;
removing the custom XML element from a document part of the Open Office XML document;
storing a text element that comprises an attribute in place of the removed custom XML element within the document part of the Open Office XML document;
storing the custom XML element within a custom XML document part of the Open Office XML document;
adding the attribute to the custom XML document part of the Open Office XML document, wherein the attribute links the text element with the custom XML element;
opening the Open Office XML document within a Microsoft Office Word® word processor; and
replacing the text element with the custom XML element within the Microsoft Office Word® word processor.

18. The non-transitory computer-readable medium of claim 17, the method further comprising saving the Open Office XML document as a XML document.

19. The non-transitory computer-readable medium of claim 17, further comprising editing the Open Office XML document.

20. The non-transitory computer-readable medium of claim 19, wherein the storing the text element and the custom XML element is performed at a content management server.
